(19) United States
(12) Patent Application Publication
(10) Pub. No.: US 2008/0100018 A1
(43) Pub. Date: May 1, 2008

(54) Vehicle suspension system

(76) Inventor: David Dieziger, Missoula, MT (US)

Correspondence Address: R. Stephen Hansell, Lawyer,;Patent Attorney, & Constr. Arb, 5240 Lower Martin Lane, Florence, MT, 59833-6817, US

(21) Appl. No.: 11/590,475

(22) Filed: Nov. 1, 2006

(51) Int. Cl. B60G 21/00; B60G 3/20

(52) U.S. Cl. 280/124.103; 280/124.135

(57) ABSTRACT

The invention is a suspension system for a three (3) or more wheeled vehicle, which vehicle tilts from the vertical plane during operation in a manner like that of a motorcycle. The suspension system divides the vehicle into two parts. The first part consists of the front, possibly the rear wheel(s), passenger compartment, and possibly a cargo compartment connected in such a way that they lean or tilt together. The second part, the rest of the vehicle, does not lean or tilt. The non-tilting components are connected to a rigid structure that extends from the front to the rear suspension where it is connected to each wheel's spring and shock absorber. The non-tilting portion of the vehicle provides resistance for each wheel's shock absorber and spring to act against, leaving the tilting portion free to lean like a motorcycle. The accompanying drawing sheets 1 through 5, inclusive, depict the suspension system with four (4) wheels and a dual “A arm” independent suspension common to many traditional motor vehicles, but the concept of which, dividing the vehicle into tilting and non-tilting components with the suspension acting on the non-tilting portion, can be adapted to a vehicle with 2 front tilting wheels with one or two rear wheels that tilt or do not tilt, other suspension springs such as coil, leaf, hydraulic, or pneumatic, and other independent or solid axle suspension systems.

REFERENCES CITED

| Ser. No. | Inventor | Date | Group Art Unit/Class |
|---|---|---|---|
| 6,874,793 | Choudhery | April 2005 | 280/5.521 |
| 5,765,897 | Braun/Daimler | June 1998 | 280/282 |
| 4,887,829 | Prince | April 1987 | 280/282 |
| 4,632,413 | Fujita et al | December 1986 | 280/112 |
| 4,515,390 | Greenberg | May 1985 | 280/675 |
| 4,478,305 | Martin, II | October 1984 | 180/215 |
| 4,375,293 | Solbes | March 1983 | 280/21 |
| 4,351,410 | Townsend | September 1982 | 280/112 |
| 3,606,374 | Capgras | September 1971 | |
| 3,089,710 | Fiola | May 1963 | |
| 2,787,473 | Chiodo | April 1957 | |

### PROVISIONAL PATENT

This invention relates to and claims priority based upon Provisional Patent No. 60/731,415, filed 31 Oct. 2005.

### BACKGROUND

Motorcycles exhibit handling characteristics which are superior in many ways over automobiles, and have less aerodynamic drag and reduced rolling resistance as compared with standard automobiles and automobile tires. Reduced aerodynamic and rolling resistance can result in improved fuel economy and vehicle performance. The preferred embodiment of the invention has four (4) tires and is therefore capable of carrying a higher gross weight than a typical motorcycle with two (2) tires. The vehicle can accommodate a larger and heavier engine, heavier fuels and loads such as batteries, more cargo, and the weight of an enclosed aerodynamic body to protect the occupants from the elements and from crashes, while reducing aerodynamic drag.

A vehicle designed around this suspension system can be constructed as narrow as a motorcycle, which is important because frontal area and shape are significant determinates of aerodynamic drag. The combination of minimal frontal area, an enclosed aerodynamic passenger/cargo compartment, and low rolling friction (drag) motorcycle tires yields improved fuel economy.

No computers, sensors, or mechanical systems are necessary to lean the vehicle or to keep it upright at speed. The only lean control mechanism required is a simple combination of bracing which will lock the vehicle in an upright position at speeds below which the gyroscopic effect of the turning wheels is insufficient to provide control-less than approximately three (3) to five (5) miles per hour.

The vehicle's suspension system can be softer and provide a smoother ride than motorcycles and many non-tilting vehicles such as autos, trucks, and ATVs. Typical motorcycle suspension systems are thirty percent (30%) to fifty percent (50%) stiffer than those of non-tilting vehicles, because motorcycles experience all of the lateral acceleration or “G” force loading occurring during turning maneuvers. The proposed suspension system experiences none of the lateral acceleration of a motorcycle, because the suspension system does not lean while turning. It remains in and acts only in the vertical like the suspension system of a typical non-leaning vehicle. Suspension systems of non-tilting vehicles must resist the forces causing the vehicle to lean to the outside of a turn and the resulting outward weight transfer. The proposed suspension system experiences no lateral weight transfer while turning because the vehicle's mass is moved to the inside of the turn, as is a motorcycle's during a balanced turn.

Compared with a typical motorcycle, this vehicle will have twice the traction—promoting shorter braking distances, improved cornering, and the ability to accommodate more powerful engines. Due to the relatively smaller contact patch of motorcycles, the vehicle is less susceptible to hydroplaning than automobiles and trucks. Having the same overall width of a motorcycle makes a vehicle easier to maneuver, requires less parking space, and it can use car pool lanes.

With two (2) front wheels, this design has inherently better front wheel traction and is more stable and safer than vehicles with one (1) tilting or fixed front wheel. As weight shifts forward as a vehicle slows and stops, front wheel traction is critical for stopping quickly, a major safety factor.

### DESCRIPTION OF THE PREFERRED EMBODIMENT

Vertical posts 1 rigidly attached to both ends of a rigid structure 2 extending the full length of a vehicle so that the vertical posts are located at or near the center of the vehicle's front and rear wheels. Opposing combination shock absorber and spring assemblies 3 are attached at the top of the posts. The lower end of the combination shock absorber and spring assembly is attached to or toward the wheel end of the lower A arms 4. The amount of force transferred by the shock absorber and spring assembly vertically and horizontally to the vertical post is determined by the lengths of the sides of the triangle comprising the shock absorber and spring assembly, the distance from the attachment point of the lower end of the shock absorber to the vertical post, and the height (length) of the vertical post. The springs incorporated within the shock absorber and spring assembly have sufficiently high spring rate and tension to maintain the vertical posts and the shock absorber and spring assembly in a vertical posture. A lengthwise structure 5 connecting the two (2) vertical posts will maintain a similar orientation as a result. The vehicle's cargo, power plant and drive train, and fuel tank are attached to the lengthwise structure connecting the two (2) vertical posts. The accompanying drawing FIG. 1 shows the vehicle with the power plant located in front of the passenger area, but the passenger area could be located above, beside, or in front of the power plant and drive train. The vehicle could employ any power plant and drive train combination including, but not limited to, internal combustion, human-powered, electric battery, hybrid, solar, or fuel cell.

A second lengthwise structure 6 extending the full length of the vehicle is located above the first lengthwise structure (carrying the vehicle's power plant, drive train, fuel, and cargo) and is attached to the vertical members extending downward at both ends to the lower (first) lengthwise structure. These vertical members are attached to the lower lengthwise structure to allow the vertical members and the second (upper) lengthwise structure to rotate around the lower (first) lengthwise structure. The inner ends of the upper A arms and passenger compartment are attached to the upper (second) lengthwise structure. Regardless of the lean angle or irregularities in the road surface, the upper and lower A arms will remain parallel (with each other) and the tires will remain parallel (with each other and with the vertical members connecting the upper and lower lengthwise members).

As depicted and revealed herein, at speeds over approximately three (3) miles per hour the vehicle will require no system—either automatic or operator controlled—to keep the vehicle upright while traveling straight, or to force it to lean while turning. The vehicle will use the gyroscopic action of the rotating wheels to remain stable, upright, or lean and turn like a motorcycle or bicycle. As the driver steers and thereby applies a horizontal torque to the front wheel(s), the front wheel(s) will generate a perpendicular vertical torque. Like a standard motorcycle, a steering input turning the front wheel(s) to the left will cause the vehicle to lean and simultaneously turn to the right. The tilting mass of the vehicle will behave and affect the vehicle's handling just like the same mass on a motorcycle. The non tilting mass of the vehicle will not lean or rotate like the tilting portion, but it will be moved to the inside of the turn as the vehicle leans or tilts just like the tilting portion. If the center of gravity of the non tilting mass is at the same level or height that it is moved from side to side, other than requiring less force to initiate a turn or directional change (because this mass does not rotate), it will have the same effect on handling as the tilting mass. At speeds below approximately three (3) miles per hour, the gyroscopic effect of the rotating wheels will be insufficient to control the vehicle. Steering will be reversed, and steering toward the right will effect a right turn and the leaning portion of the vehicle will have to be locked upright or the driver will have to put his feet down.

The suspension system provides effective individual damping of each wheel in that each wheel has its own damping system/shock absorber and the actions of each wheel and forces generated by each damping system/shock absorber and spring assembly will have minimal impact upon other damping system/shock absorber(s), spring assembly(s) and wheel(s). The reasons for this effect are:

1. All of the vehicle's shock absorbers are connected to the non-leaning lengthwise rigid structure. When one shock absorber reacts to a bump, its actions will be distributed to and resisted by the other shock absorbers and suspension springs. In the example set forth in the accompanying drawings, the forces generated by each shock absorber will be distributed to and resisted by three (3) other shock absorbers and springs.

2. Most of the vehicle's mass is carried by the non-leaning portion of the vehicle. Increasing the mass of the non-leaning rigid structure connecting the vehicle's suspension systems will increase the non leaning structure's inertia, further reducing the effect one shock absorber has on the vehicle's other shock absorber(s) and wheel(s).

The vehicle will lean and therefore respond to directional changes easier and more quickly for its overall mass. The non-leaning mass is moved to the inside of a turn just like the leaning mass, but it does not lean or rotate like all the mass does on a typical motorcycle. Since the non-leaning mass does not rotate it will be easier to change the lean angle and turn the vehicle than if the entire mass of the vehicle were to rotate when initiating a turn.

### DESCRIPTION OF THE DRAWINGS

FIG. 1 is an oblique front view (not to scale) from below the vehicle, depicting the front and rear pivot points, with the left and right shock absorbers of the front and rear vertical posts are connected near the top of the vertical posts and to the lower A-arms near the wheels, and an engine and transmission (in which no rights are claimed) and a driveline (in which no rights are claimed) are shown for reference only.

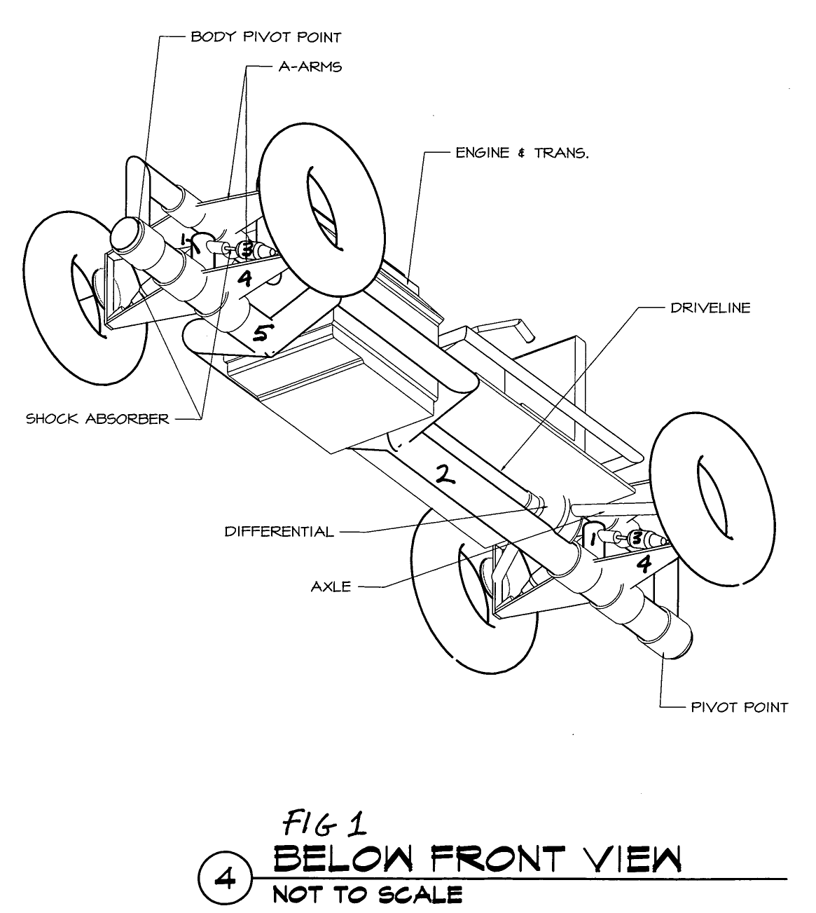

FIG. 2 is an oblique rear view from above, depicting the tilting portion of the passenger/cargo compartment and the front and rear pivot points and upper pivot beam, with the right front and rear wheel joints (in which no rights are claimed) shown for reference only.

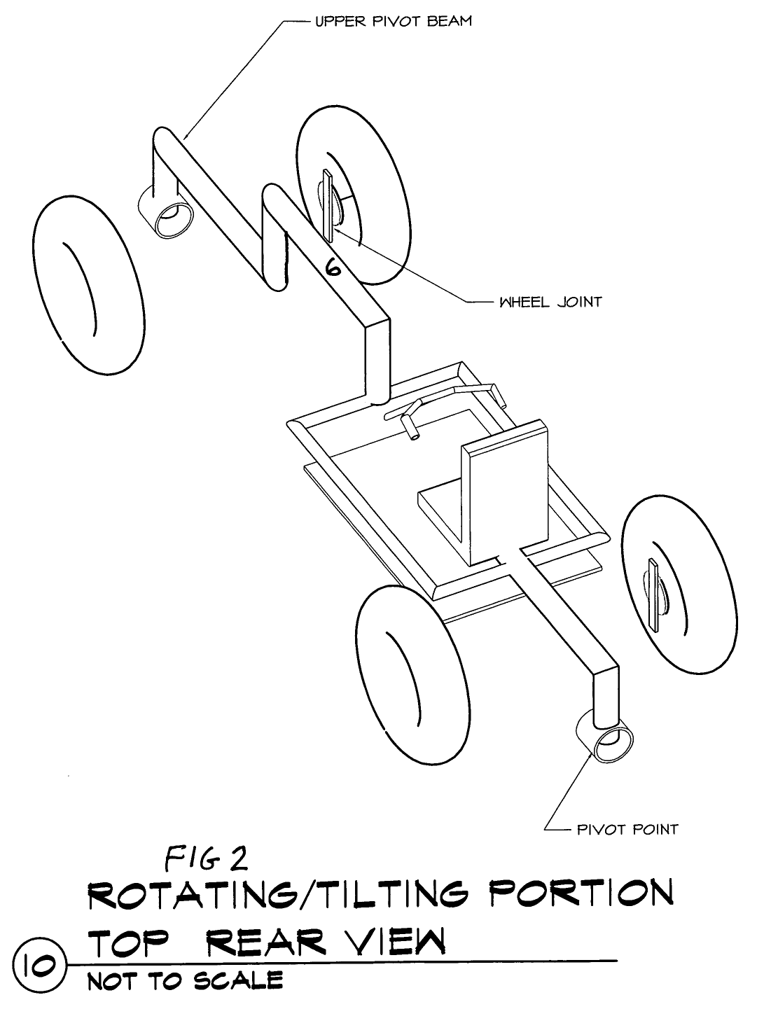

FIG. 3 is an oblique front view from below, depicting the tilting portion of the passenger/cargo compartment and the front and rear pivot points and upper pivot beam, with the right front and rear wheel joints (in which no rights are claimed) are shown for reference only.

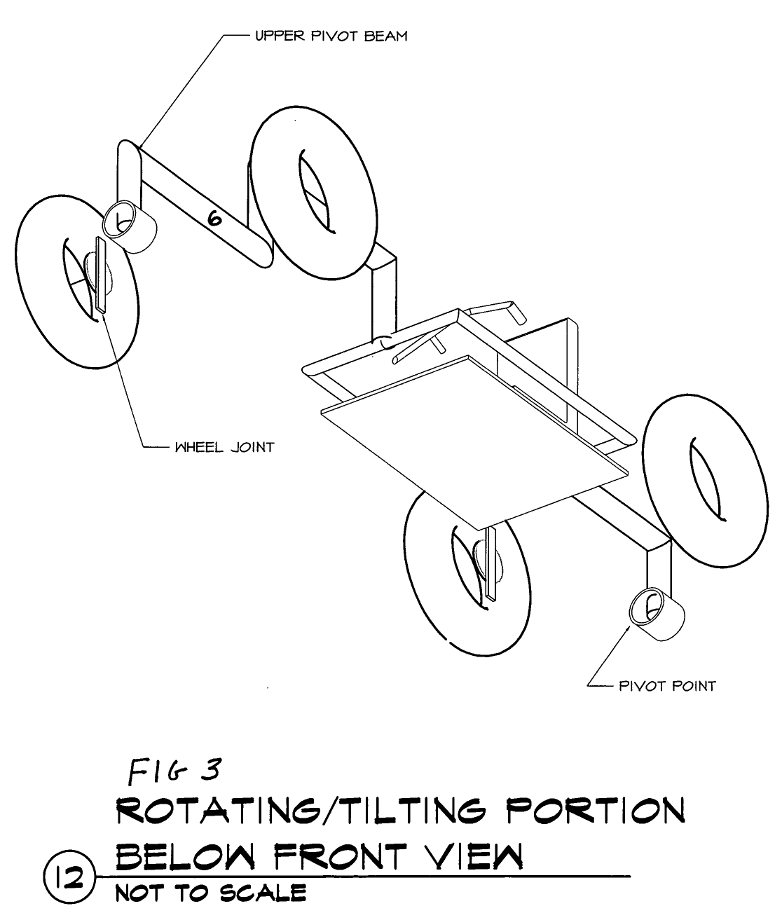

FIG. 4 is an oblique rear view from above, depicting the non-tilting portion of the engine and transmission power plant (in which no rights are claimed) and the driveline (in which no rights are claimed), with the upper and lower front and rear A-arms and shock absorbers are shown, which shock absorbers are connected near the tops of the front and rear vertical posts and at the outside of the lower A-arms near the wheels.

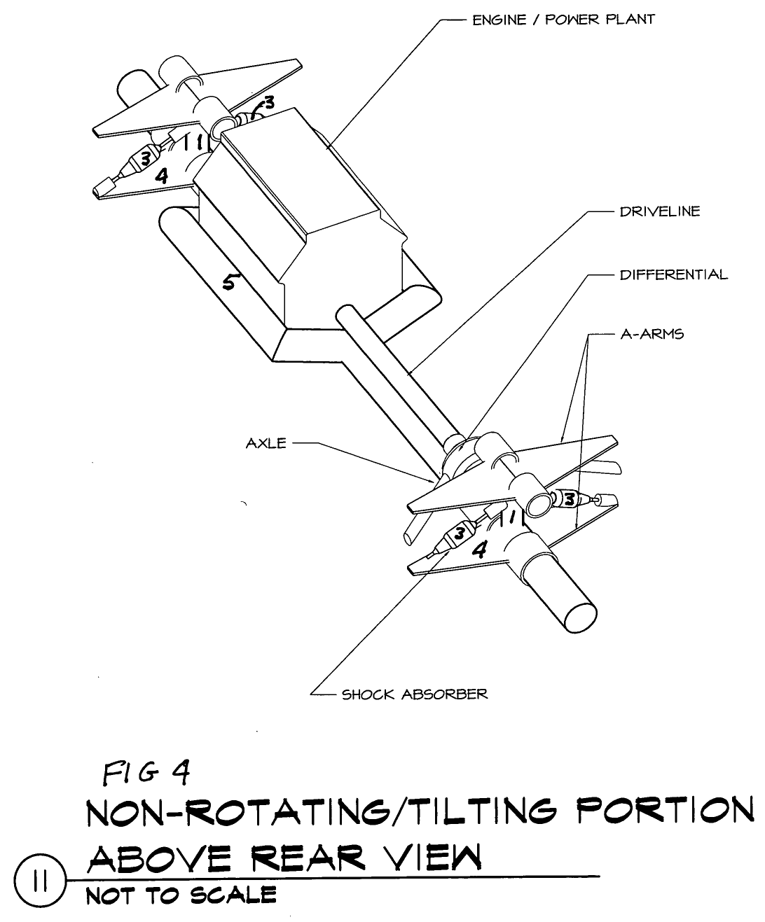

FIG. 5 is an oblique front view from below of the non-tilting portion of the engine and transmission power plant (in which no rights are claimed) and the driveline (in which no rights are claimed), and the differential (in which no rights are claimed), depicting the upper and lower front and rear A-arms, the axle (in which no rights are claimed), and the shock absorbers, connected to the front and rear vertical posts near the top of the posts and at the outside of the lower A-arms near the wheels.

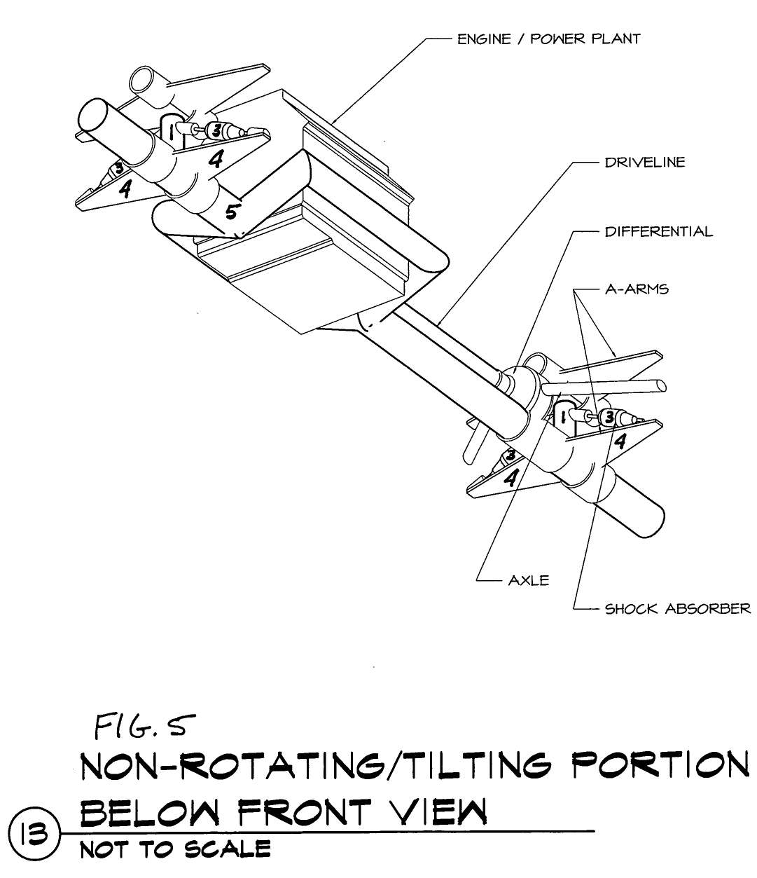

I claim:

1. A vehicle suspension system consisting of vertical posts attached to both ends of a rigid structure extending the full length of a motorized vehicle having wheels where the vertical posts are near the center of the front and rear wheels, and a second lengthwise structure above the first rigid structure, which second structure is attached to the vertical posts above the first structure so as to allow the second (upper) structure to rotate around the first (lower) lengthwise structure, with opposing combination shock absorber and spring assemblies connected to the top of the vertical posts, with the lower end of the combination shock absorber and spring assembly attached to or toward the wheel end of the lower A arms.

2. The vehicle suspension system described in 1 above, wherein the inner A arms and passenger compartment are attached to the second (upper) structure to enable the upper and lower A arms to remain parallel with each other and the wheels to remain parallel with each other and with the vertical members connecting the upper and lower lengthwise structures regardless of the lean angle or irregularities in the road surface.

3. The vehicle suspension system described in 2 above, wherein the vehicle has three (3) wheels.

4. The vehicle suspension system described in 2 above, wherein the vehicle has four (4) wheels.

5. The vehicle suspension system described in 2 above, wherein the vehicle has more than four (4) wheels.
